(19) United States
(12) Patent Application Publication
(10) Pub. No.: US 2013/0060558 A1
(43) Pub. Date: Mar. 7, 2013

(54) UPDATING OF INTERFACES IN NON-EMULATED ENVIRONMENTS BY PROGRAMS IN THE EMULATED ENVIRONMENT

(71) Applicants: Jason Schultz, Plymouth, MN (US); Robert Bergerson, Blaine, MN (US); James Heit, Vadnais Heights, MN (US); John Peters, Coon Rapids, MN (US)

(72) Inventors: Jason Schultz, Plymouth, MN (US); Robert Bergerson, Blaine, MN (US); James Heit, Vadnais Heights, MN (US); John Peters, Coon Rapids, MN (US)

(21) Appl. No.: 13/226,824

(22) Filed: Sep. 7, 2011

(51) Int. Cl. G06F 9/455

(52) U.S. Cl. 703/23

(57) ABSTRACT

Updates to components of an interface may be carried out from a program executed in an emulated environment. For example, an interface that provides communications for the program in the emulated environment to the host operating system may be updated from the program in the emulated environment. Centralizing updates through the program improves the likelihood that components, such as the interface, have compatible versions with the program executing in the emulated environment. Thus, as the program is updated other components are updated by the program.

The instant disclosure relates to updating software. More specifically, this disclosure relates to updating software within emulated environments.

### BACKGROUND

Servers often have multiple software packages installed and operating together to provide services to local and remote users. A server may even run software packages designed for other systems through an emulated environment. The emulated environment communicates with other software packages on the server, such as interfaces, to allow software executing within the emulated environment to access hardware on the server. Because of the close interaction between software within the emulated environment and an operating system on the server, the software packages may be designed for operation with specific versions of other software packages. When one software package on the server is updated, other software packages may need to be updated to accommodate changes in the software package.

FIG. 1 is a block diagram illustrating a conventional server hosting an emulated environment. An operating system 102 executing on a server includes a networking layer 104. The operating system 102 may be, for example, Linux. An emulated environment 108 in the operating system 102 executes a program 110, such as CPCommOS. The program 110 accesses the networking layer 104 of the operating system 102 through a non-emulated interface 106, such as XNIOP. The non-emulated interface 106 translates requests from the program 110 executing in the emulated environment 108 for the networking layer 104 of the operating system 102. The non-emulated interface 106 interacts closely with the program 110. Thus, if an update to program 110 occurs, the non-emulated interface 106 may need to be updated to allow the non-emulated interface 106 to continue operating with the program 110.

Conventionally, updates are carried out on the program and interface through separate processes. For example, the program may be updated through a symbolic code change provided to the user, who then builds the change into the program and reinstalls the program. The interface may be separately updated through a resource package manager (RPM). One or both of these update procedures may require making the server hosting the software unavailable.

When both the program and the interface need updates, the user may become frustrated with the time consumed with updating different software packages. Additionally, the program and the interface may be updated through different procedures. Thus, even a small change in one program may result in two different update procedures carried out by an administrator. If updates are not applied to both software packages, the software packages no longer operate together correctly.

### SUMMARY

According to one embodiment, a method includes querying, by a program executing in an emulated environment, a status of an interface to an operating system. The method also includes receiving the status for the interface including a version number and a sleep time. The method further includes transmitting a load file for the interface when the version number for the interface is lower than a version of the load file. The method also includes waiting a time specified by the sleep time received in the status for the interface. The method further includes initializing the interface for communication with the program.

According to another embodiment, a computer program product includes a non-transitory computer readable medium having code to query, by a program executing in an emulated environment, a status of an interface to an operating system. The medium also includes code to receive the status for the interface including a version number and a sleep time. The medium further includes code to transmit a load file for the interface when the version number for the interface is lower than a version of the load file. The medium also includes code to wait a time specified by the sleep time received in the status for the interface. The medium further includes code to initialize the interface for communication with the program.

According to yet another embodiment, an apparatus includes a memory and a processor, in which the processor is configured to query, by a program executing in an emulated environment, a status of an interface to an operating system. The processor is also configured to receive the status for the interface including a version number and a sleep time. The processor is further configured to transmit a load file for the interface when the version number for the interface is lower than a version of the load file. The processor is also configured to wait a time specified by the sleep time received in the status for the interface. The processor is further configured to initialize the interface for communication with the program.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a conventional server hosting an emulated environment.

FIG. 2 is a flow chart illustrating an exemplary method for updating an interface from an emulated environment according to one embodiment of the disclosure.

FIG. 3 is a flow chart illustrating an exemplary method for a program in an emulated environment to interact with an interface to an operating system according to one embodiment of the disclosure.

FIG. 4 is a flow chart illustrating an exemplary method of updating an interface according to one embodiment of the disclosure.

FIG. 5 is block diagram illustrating a computer network according to one embodiment of the disclosure.

FIG. 6 is a block diagram illustrating a computer system according to one embodiment of the disclosure.

### DETAILED DESCRIPTION

An update procedure may be improved by carrying out updates through one component. For example, updates may be provided to the program in the emulated environment and the program updates the interface that interacts with the program. Thus, update management may be centralized and monitored at one component. Centralizing update management may reduce burden on the administrator for performing updates and reduce the likelihood that incompatible versions of the program and the interface co-exist.

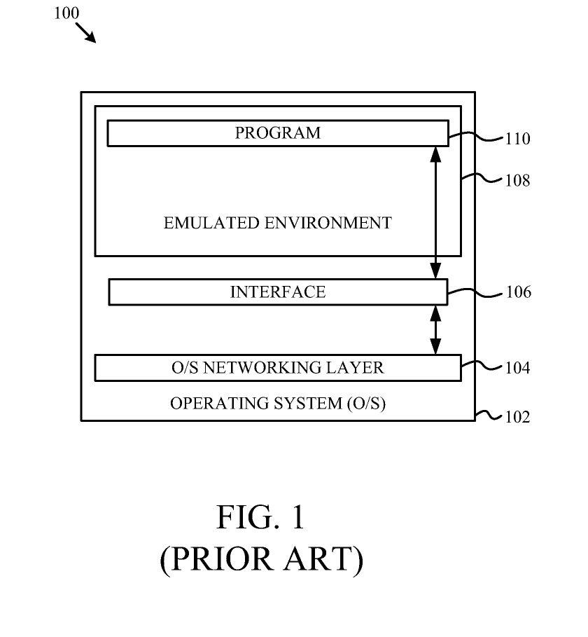

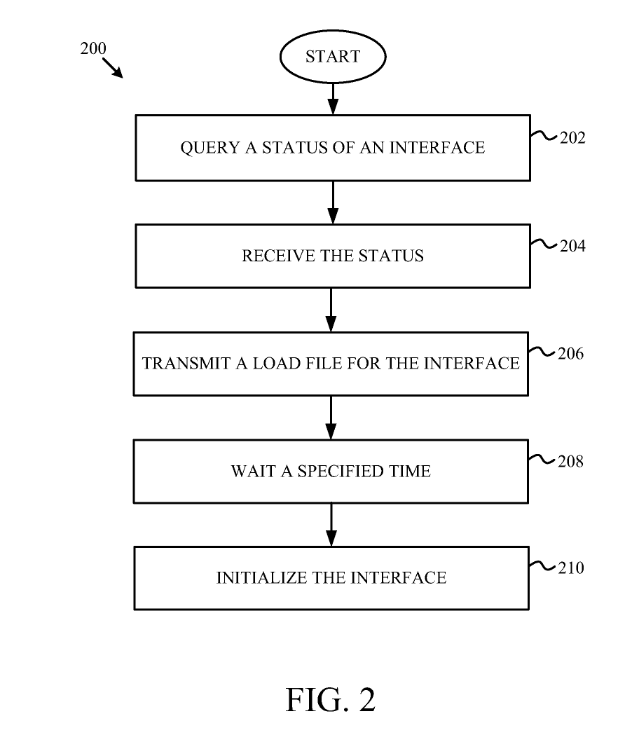

FIG. 2 is a flow chart illustrating an exemplary method for updating an interface from an emulated environment according to one embodiment of the disclosure. A method 200 begins at block 202 with querying a status of an interface. A program, such as the program 110 operating in the emulated environment 108 of FIG. 1, may query an interface, such as the interface 106. The query may be transmitted in a version query packet. At block 204 status information, such as a version number of the interface, may be received by the program.

At block 206 the program may transmit a load file to the interface. The load file may include an update to the interface, such as new microcode. The load file may be transmitted at block 206 based on status information received at block 204. For example, if the version number of the interface is less than the version number of the load file, then the load file may be transmitted at block 206. The load file may be divided into packets, which are individually transmitted to the interface. A size for the packets may be specified by a configuration file in the program, or the size may be specified in the response received at block 204. At block 208 the program waits a specified period of time for the update to occur at the interface using the transmitted load file. The wait time may be specified in the status information received at block 204. After waiting, the method 200 proceeds to block 210 to initialize the interface and proceed to transmit data to the interface.

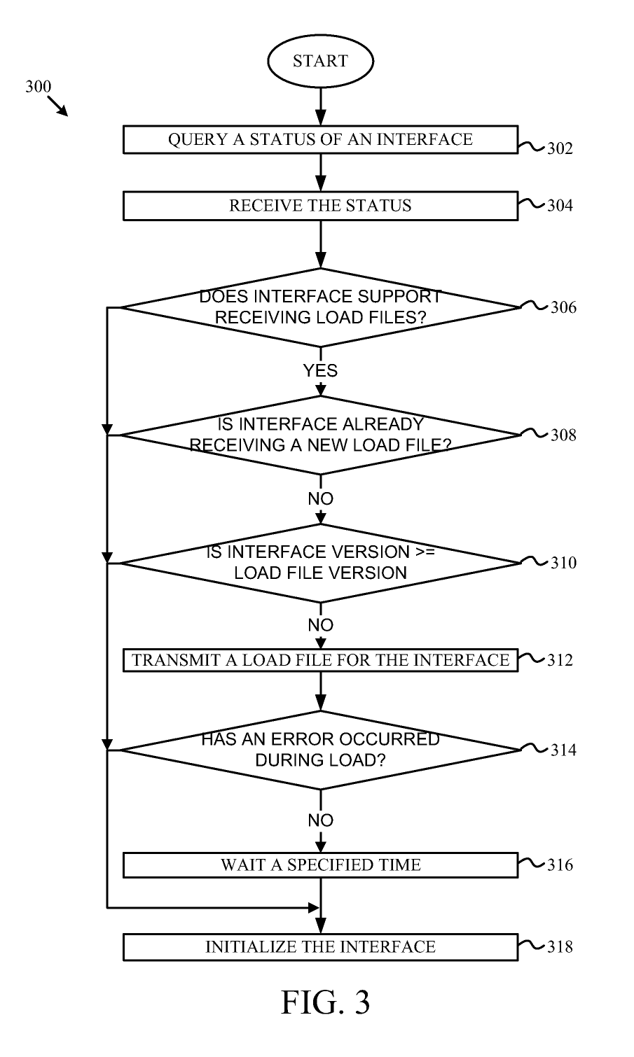

A method for updating the interface from the program is described in more detail with reference to FIG. 3. FIG. 3 is a flow chart illustrating an exemplary method for a program in an emulated environment to interact with an interface to an operating system according to one embodiment of the disclosure. A method 300 begins at block 302 with querying a status of an interface. At block 304 the status information is received. The status information may include a version number, a load filename, an indication of whether loads are allowed, a sleep time for processing loads, and/or an optional message, which may be used for error codes. The status information may instead include an error code indicating that the interface does not recognize the query at block 302.

When the interface does not recognize the query at block 302, the interface does not support receiving load files for updating the interface. This may be caused by the interface having a version too old to recognize the commands associated with receiving a load file, such as the query command of block 302. At block 306 it is determined whether the interface supports receiving load files. If the interface does not support receiving load files then the method 300 continues to block 318 with initializing the interface to receive data from the program. When the interface does support receiving load files for updating the interface, the method 300 continues to block 308.

At block 308 the program determines if the interface is already receiving a load file from a separate program operating in the emulated environment. That is, the emulated environment may host multiple copies of a program or multiple programs. According to one embodiment, the interface may only receive a load file from one program at a time. Thus, if the interface is already receiving a load file from another program then the method 300 continues to block 318 with initializing the interface to receive data from the program. Information regarding whether the interface is already receiving a load file from another program may be included in the query response of block 304. When the interface is not already receiving a load file from another program the method 300 continues to block 310.

At block 310 it is determined whether the interface version is greater than the load file available to the program. The version information for the interface may be received in the status query response of block 304. When the interface version is greater than or equal to the version of the load file, the method 300 continues to block 318 to initialize the interface to receive data from the program. When the interface version is less than the version of the load file, the method 300 continues to block 312 to transmit the load file for the interface.

At block 314 it is determined whether an error occurred during transmission of the load file at block 312. If an error occurred then the method 300 continues to block 318 to initialize the interface to receive data from the program. According to one embodiment, the program instead may return to block 312. If no error occurred then the method 300 continues to block 316 to wait a specified period of time. The wait time of block 316 may be specified by information received in the query response of block 304. According to one embodiment, the wait time allows the interface to update according to the load file. After the wait time at block 316 has passed, the method 300 continues to block 318 to initialize the interface to receive data from the program.

Although blocks 306, 308, and 310 are described in a specific order, the steps of the method 300 carried out in block 306, 308, and 310 may be carried out in a different order from that described here. For example, block 310 may be performed before block 308. If an error occurs during the method 300, such as the interface is already receiving a load file from another program or the interface does not support receiving load files, an administrator or user may be notified of the error. The error may be displayed along with additional information received from the interface in an optional error message received in a separate packet.

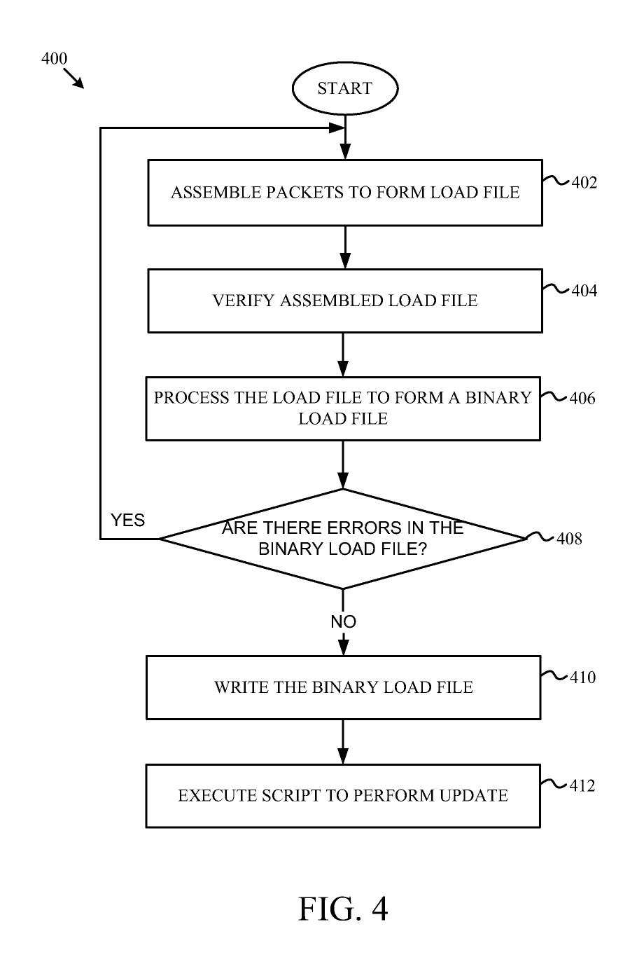

When the load file is received at the interface, the interface may process the load file and execute instructions to update the interface according to the load file. FIG. 4 is a flow chart illustrating an exemplary method of updating an interface according to one embodiment of the disclosure. A method 400 begins at block 402 with assembling packets to form the load file. The size of the load file and other characteristics of the load file may be read from a header at the beginning of the load file. At block 404 the assembled load file is verified. For example, a cyclic redundancy check (CRC) may be performed on the assembled file to insure there were no errors during transmission of the load file. At block 406 the load file is processed to form a binary load file. At block 408 it is determined whether there are any errors in the binary load file. If there are errors at block 408 then the method 400 continues to block 402 to await transmission of a new load file. If there are no errors at block 408 then the method 400 continues to block 410 to write the binary load file.

At block 412 a script is executed to perform the update on the interface using the binary load file of block 410. The script may be generated and placed in a temporary location for execution to update the interface. According to one embodiment, the shell script may include any sequence of commands that an administrator or user desires and may be modified from one version to another version of the interface. For example, the script may include commands to clean up temporary files no longer in use by the operating system or the interface after the update has completed. The script may be located in a defined section of the load file of block 410, which may be extracted and executed.

The procedure described above may automate updating of components such as the interface. According to one embodiment, the status inquiry and update procedure is performed upon initialization of a program or the first time the interface is accessed from the program. Although an automated procedure for updating the interface is described above, the procedure may also be initiated manually.

According to one embodiment, a command may be available to users or administrators in the program to execute the update. The user or administrator may issue a command to begin the procedure described above. The user or administrator may also issue a command to begin the procedure described above without performing the version level query. That is, the user or administrator may force the load file to update the interface regardless of the version number of the load file and the version number of the interface. Thus, if the load file at the interface becomes corrupted the user or administrator may force a re-load of the load file.

According to another embodiment, the program may be configured to disable automatic updating of the interface. For example, an administrator may configure the program to not execute the query at the initialization of the interface.

Updating the interface to the operating system for a program in an emulated environment through the methods described above improve the likelihood that the version of the program and the version of the interface match, such that there are few or no conflicts between the program and the interface due to version mismatch. Additionally, the update to the interface occurs without downing the program or a partition executing the program.

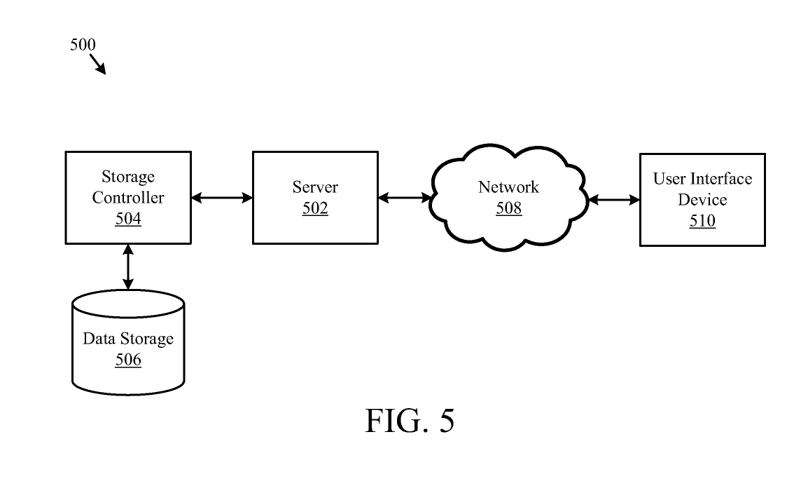

FIG. 5 illustrates one embodiment of a system 500 for an information system, such as a system for executing programs in an emulated environment. The system 500 may include a server 502, a data storage device 506, a network 508, and a user interface device 510. The server 502 may be a dedicated server or one server in a cloud computing system. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other a mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and provide a user interface for enabling a user to enter or receive information.

The network 508 may facilitate communications of data, such as authentication information, between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 510 accesses the server 502 through an intermediate sever (not shown). For example, in a cloud application the user interface device 510 may access an application server. The application server fulfills requests from the user interface device 510 by accessing a database management system (DBMS), which stores authentication information and associated action challenges. In this embodiment, the user interface device 510 may be a computer or phone executing a Java application making requests to a JBOSS server executing on a Linux server, which fulfills the requests by accessing a relational database management system (RDMS) on a mainframe server.

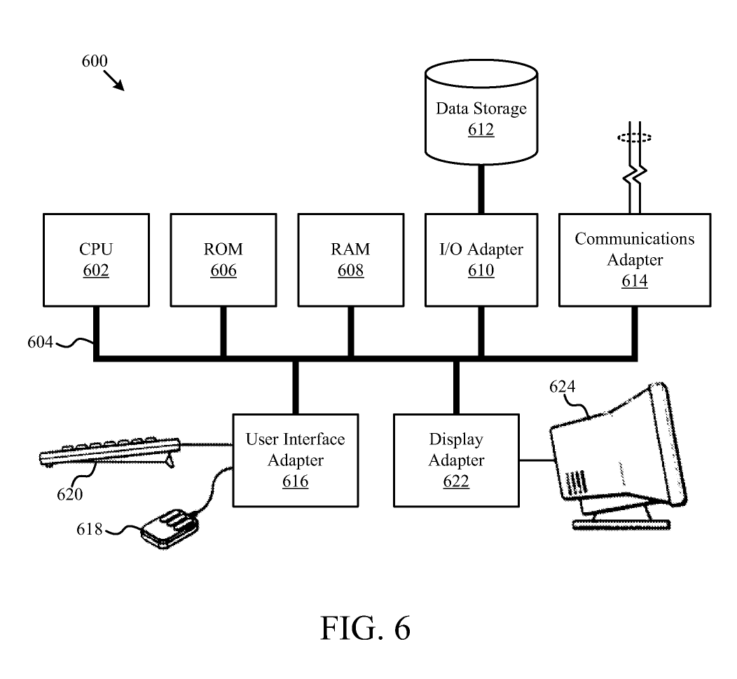

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the modules and operations as described herein. The CPU 602 may execute the various logical instructions according to the present embodiments.

The computer system 600 also may include random access memory (RAM) 608, which may be synchronous RAM (SRAM), dynamic RAM (DRAM), and/or synchronous dynamic RAM (SDRAM). The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a flash drive, a compact disc (CD) drive, a floppy disk drive, and a tape drive, to the computer system 600. The communications adapter 614 may be adapted to couple the computer system 600 to the network 508, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or a gyroscope may be coupled to the user interface adapter 616. The display adapter 622 may be driven by the CPU 602 to control the display on the display device 624.

The applications of the present disclosure are not limited to the architecture of computer system 600. Rather the computer system 600 is provided as an example of one type of computing device that may be adapted to perform the functions of a server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
querying, by a program executing in an emulated environment, a status of an interface to an operating system;
receiving the status for the interface including a version number and a sleep time;
transmitting a load file for the interface when the version number for the interface is lower than a version of a load file stored by the program;
waiting a time specified by the sleep time received in the status for the interface; and
initializing the interface for communication with the program.

2. The method of claim 1, in which the step of transmitting the load file comprises transmitting the load file in pieces having a size specified by a configuration file.

3. The method of claim 1, in which the step of receiving the status further comprises receiving a message indicating a load file may be received by the interface, and in which the method further comprises not transmitting the load file when the received message indicates the load file may not be received by the interface.

4. The method of claim 1, further comprising not transmitting the load file when the version number for the interface is higher or equal to the version of the load file.

5. The method of claim 1, further comprising updating the interface with the load file while waiting the time specified by the sleep time.

6. The method of claim 5, in which the step of updating comprises:
assembling, by the interface, the load file;
verifying, by the interface, the load file;
processing, by the interface, the load file to form a binary load file; and
writing, by the interface, the binary load file to the interface when no errors are found in the load file during the step of assembling, the step of verifying, and the step of processing.

7. The method of claim 6, in which the step of updating further comprises:
copying a script to a temporary location; and
executing the script to update the interface.

8. A computer program product, comprising:
a non-transitory computer readable medium comprising:
code to query, by a program executing in an emulated environment, a status of an interface to an operating system;
code to receive the status for the interface including a version number and a sleep time;
code to transmit a load file for the interface when the version number for the interface is lower than a version of a load file stored by the program;
code to wait a time specified by the sleep time received in the status for the interface; and
code to initialize the interface for communication with the program.

9. The computer program product of claim 8, in which the code to transmit the load file comprises code to transmit the load file in pieces having a size specified by a configuration file.

10. The computer program product of claim 8, in which the code to receive the status further comprises code to receive a message indicating a load file may be received by the interface, and in which the medium further comprises code to not transmit the load file when the received message indicates the load file may not be received by the interface.

11. The computer program product of claim 8, in which the medium further comprises code to not transmitting the load file when the version number for the interface is higher or equal to the version of the load file.

12. The computer program product of claim 8, in which the medium further comprises code to update the interface with the load file while waiting the time specified by the sleep time.

13. The computer program product of claim 12, in which the medium further comprises:
code to assemble, by the interface, the load file;
code to verify, by the interface, the load file;
code to process, by the interface, the load file to form a binary load file; and
code to write, by the interface, the binary load file to the interface when no errors are found in the load file during the step of assembling, the step of verifying, and the step of processing.

14. The computer program product of claim 13, in which the medium further comprises:
code to copy a script to a temporary location; and
code to execute the script to update the interface.

15. An apparatus, comprising:
a memory; and
at least one processor, in which the at least one processor is configured:
to query, by a program executing in an emulated environment, a status of an interface to an operating system;
to receive the status for the interface including a version number and a sleep time;
to transmit a load file for the interface when the version number for the interface is lower than a version of a load file stored by the program;
to wait a time specified by the sleep time received in the status for the interface; and
to initialize the interface for communication with the program.

16. The apparatus of claim 15, in which the at least one processor is further configured to transmit the load file in pieces having a size specified by a configuration file.

17. The apparatus of claim 15, in which the at least one processor is further configured to not transmit the load file when the version number for the interface is higher or equal to the version of the load file

18. The apparatus of claim 15, in which the at least one processor is further configured:
to assemble, by the interface, the load file;
to verify, by the interface, the load file;
to process, by the interface, the load file to form a binary load file; and
to write, by the interface, the binary load file to the interface when no errors are found in the load file during the step of assembling, the step of verifying, and the step of processing.

19. The apparatus of claim 18, in which the at least one processor is further configured:
to copy a script to a temporary location; and
to execute the script to update the interface.

20. The apparatus of claim 15, in which the memory stores the emulated environment and the at least one processor executes the program and the interface.
